(19) United States
(12) Patent Application Publication
(10) Pub. No.: US 2005/0218758 A1
(43) Pub. Date: Oct. 6, 2005

(54) Bayonet latch

(75) Inventors: Clinton Charles Thackery, Anderson, SC (US); Kenneth M. Brazell, Piedmont, SC (US)

Correspondence Address: G. Peter Nichols;Brinks Hofer Gilson & Lione, NBC Tower, Suite 3600, P.O. Box 10395, Chicago, IL, 60610, US

(73) Assignee: ONE WORLD TECHNOLOGIES LIMITED

(21) Appl. No.: 10/817,099

(22) Filed: Apr. 2, 2004

(51) Int. Cl. H01R 13/44; E05C 7/06

(52) U.S. Cl. 312/222

(57) ABSTRACT

A bayonet latch that includes a rotatable locking member having a slot to receive a pin provided on a stem such that when the locking member is in a first position the pin can pass through the slot and when the locking member is in a second position, the pin cannot pass through the slot.

### BACKGROUND OF THE INVENTION

The present invention relates to a latch that is useful for securing two halves of a housing. In particular, the present invention relates to a bayonet latch that can be used to secure one member of a housing to another member of a housing. The bayonet latch of the present invention may find particular use in securing mating members of a housing used for machinery such as power tool housings and specifically band saw or other types of saw housings.

Housings are, of course, well known. They typically include a first member (door) that is connected to a second member, such as by a hinge. To secure the first member to the second member, it is well known to provide a latch, clasp, clip, buckle, etc. Although many of these latches and the like are satisfactory, they can still be improved.

Known problems include, bending of the latch, seating of the latch misalignment of the latch among other problems. Oftentimes, housings are used for power tools such as a band saw where it is desirable not only to seal the first and second members (to minimize or prevent dust from entering) but also to provide access to the interior when needed. When a housing is used with this type of tool as well as with similar types of tools, the housing is subject to vibrations simply due to operation of the tool. As a result, it is important that the latch, when engaged, stays engaged to prevent an undesired separation of the members of the housing.

The bayonet latch of the present invention addresses one or more of the existing problems of the known latches. One advantage of the bayonet latch of the present invention is that it can be constructed to provide continual tension urging the housing members together, which will allow for variations in the tolerances in the manufacturing process and will improve the seal of the mating members as well as reduce the vibration between them.

### SUMMARY

According to the present invention, a bayonet latch is provided. The bayonet latch includes a rotatable locking member having a slot and a stem having a pin. When the locking member is in a first position, the pin can pass through the slot and when the locking member is rotated to a second position, the pin cannot pass through the slot. In the second position, the stem is engaged with the locking member.

In general, the bayonet latch is used with a housing having a first member, i.e., a door, and a second member. The first member may be hinged to the second member or the first member may simply engage the second member in a mating fashion. The manner of how the first and second members engage and disengage from each other is not particularly important, because it is believed that the bayonet latch of the present invention can be used to latch a variety of mating members. As is known, the first member has an outer surface and an inner surface and the second member has an outer surface and an inner surface. When the first member is engaged with the second member, the inner surface of the first member is opposite the inner surface of the second member.

In general, the first member has an aperture to receive the locking member such that the locking member is secured within the aperture. The locking member, however, is free to move both axially and rotationally. The locking member has a portion that is visible to and can be grasped by the user so that the locking member can be both rotated and pushed in an axial direction. The visible portion of the locking member may be provided with an indicator to indicate the location of the slot.

A boss is provided and it extends from the inner surface of the second member. The boss receives one end of the stem. The other end of the stem has a pin. When the locking member is in a first position and the first member and the second member are brought toward contact with each other, the pin can pass through a slot provided on the locking member. When the first member and the second member are engaged, the locking member can be rotated to a second position such that the pin cannot pass through the slot. In this second position, the first member is secured to the second member.

A biasing member such as a spring may be provided to bias the locking member outward or away from the first housing member. When a spring is provided, its biasing force provides a continual tension urging the first member and the second member in a mating position.

### BRIEF DESCRIPTION OF THE DRAWINGS

FIG. 1 shows an exploded perspective view of one embodiment of a bayonet latch according to the present invention in relationship with two housing members.

FIG. 2 shows a cross sectional perspective view of another embodiment of the bayonet latch of FIG. 1 in relationship with two housing members when the housing members are in a closed position and the bayonet latch is locked.

FIG. 3 is a side cross sectional view of the bayonet latch of FIG. 2 in relationship with two housing members when the housing members are in a closed position and the bayonet latch is locked.

FIG. 4 is a side cross sectional view of the bayonet latch of FIG. 2 with the locking member of the bayonet latch in an unlocked position and the two housing members in an unlocked position.

### DESCRIPTION

Turning now to FIG. 1, a bayonet latch 10 according to the present invention is shown. In general, the bayonet latch 10 includes a locking member 20 and a stem 70. As seen in FIG. 1, the bayonet latch 10 is shown in use with a housing 100 that has mating members 110, 130. For ease of description, the bayonet latch 10 of the present invention will be described in connection with the housing 100 shown in FIGS. 1-4. It is to be understood and one of skill in the art will understand that the bayonet latch 10 of the present invention can be used to latch or fasten any variety of members one to another as is known in the art of latching. For example, the bayonet latch 10 may be used to latch a door to a frame, a lid to a box, members of housings for implements such as power tools, or the like. It is contemplated that the bayonet latch 10 of the present invention will be useful in securing the members of a housing for a power tool such as a band saw, where oftentimes it is desirable to provide a housing that can be opened but that the user wishes to be securely held shut to prevent or minimize contamination of the inner workings from dust and the like.

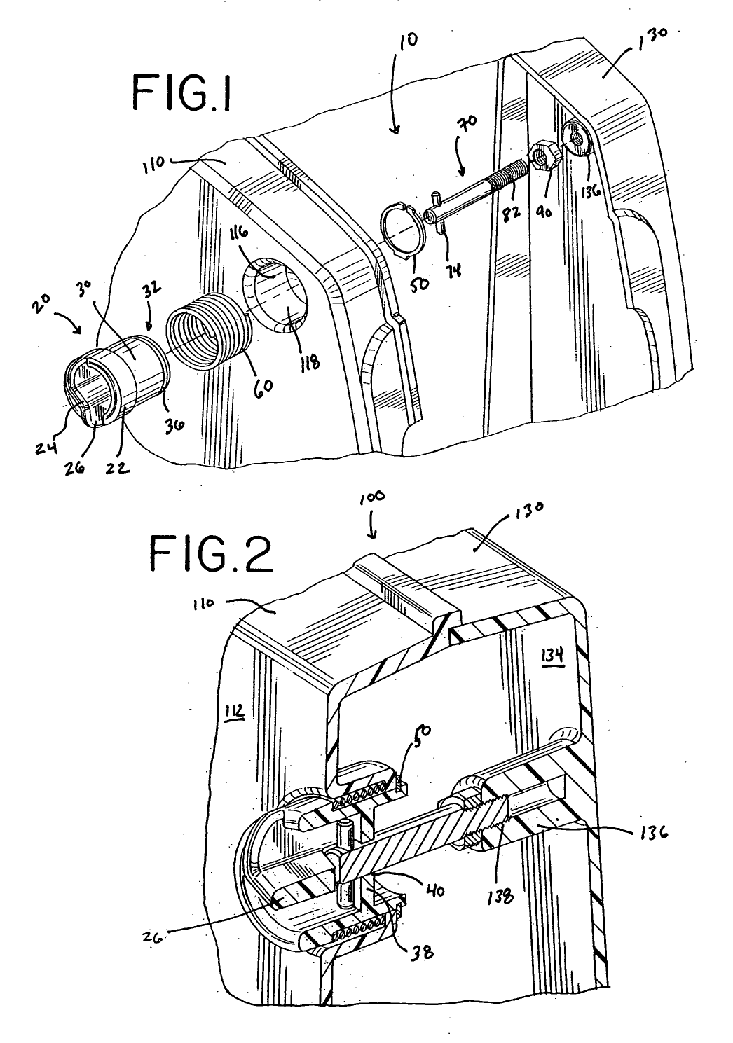

When the bayonet latch 10 is used with a housing 100, as shown in the figures, the housing 100 will typically have a first member 110 with a first side 112 and a second side 114. As shown in FIG. 1, the first side 112 is considered the outside of the housing 100 and is visible to the user, when the housing 100 is in a closed position (as shown in FIGS. 2 and 4). Accordingly, the second side 114 is considered to form the inside of the housing 100 when the housing 100 is in the closed position. Similarly, the housing 100 has a second member 130 with a first side 132 and a second side 134. As shown in FIG. 1, the first side 132 is considered the outside of the housing 130 and may be visible to the user when the housing 100 is in a closed position. Accordingly, the second side 134 is considered to form the inside of the housing 100 when the housing 100 is in the closed position.

The locking member 20 is disposed in the first member 110 and the stem 70 is disposed in the second member 130 such that when the first member 110 is brought toward the second member 130, the stem 70 can engage the locking member 20. It is to be understood that the locking member 20 and the stem 70 can be disposed in the first 110 and second member 130, respectively, in a variety of different ways and the manner in which they are disposed is not critical to the invention.

As shown in FIG. 1, the first member 110 has an aperture 116 with a wall 118 that extends from the first side 112 toward the second side 114 and terminates in a flange 120. The aperture 116 receives the locking member 20 and therefore may have any suitable shape to mate with the locking member 20. The second member 130 has a boss 136 to receive the stem 70. The boss 136 is provided on the second side 134 such that when the housing 100 is in a closed position, the boss 136 extends toward the second side 114 of the first member 110.

Referring now to the bayonet latch 10, as noted before, it includes a locking member 20 and a stem 70. The locking member 20 is received in the aperture 116 provided in the first member 110 of the housing 100. Accordingly, the locking member 20 and the aperture 116 have complementary shapes. The locking member 20 is received in the aperture 116 in a manner such that the locking member 20 can move in both an axial direction and in a rotational direction yet be secured in the first member 110 so that the locking member 20, once installed does not become disengaged from the first member 110.

The locking member 20 is desirably cylindrical and formed from one piece. The locking member 20 may be formed from any suitable material with plastic being a desirable material. The locking member 20 can be formed as a single piece and when formed from plastic, can be integrally molded.

The locking member 20 has a head 22 and a body 30. The head 22 is shaped such that it can be grasped by a user to rotate the locking member 20 and to push the locking member 20 inward in an axial direction. Desirably, the outer circumference of the head 20 is larger than the outer circumference of the body 30 such that where they meet a ledge 34 is defined. The top portion 24 of the head 22 may be provided with an indicator 26, the purpose of which will become clear from the following description. The indicator 26 may take the form of indicia provided on the head, coloring that differs from the general color of the locking member 20, differing shape of a portion of the head 22, or a structure formed as part of the head 22, among other things. As shown in FIG. 1, the indicator 26 may be in the form of a tear drop shape formed in the inner circumferential portion of the head 22. As shown in FIG. 2, the indicator 26 is in the form of a rib that extends from one portion of the head 22 across to another portion.

The body 30 has a free end 32 that extends beyond the flange 120 of the aperture 116 toward the second housing member 130. A groove 36 is provided adjacent the free end 32 to receive a spring clip 50 or other type of engagement member such that the locking member 20 will be secured in the aperture 116. Of course, other means of securing the locking member 20 to the first housing member 110 may be used.

The locking member 20 has an inner wall 38 that has an aperture 40 to receive the stem 70. The aperture 40 is desirably centrally located within the locking member 20. At least one slot 42 extends radially outward from the aperture 40. In one embodiment, two slots 42 extend radially outward from the aperture 40 with the slots 42 being opposite each other or in the same plane. As noted above, the head 22 of the locking member 22 is desirably provided with an indicator 26. The indicator 26 is oriented, constructed, or otherwise provided to indicate the orientation of the slot 42 so that the user, upon viewing the indicator 26 can readily determine whether the locking member 20 is in a locked position or an unlocked position.

In one embodiment, a biasing member 60 generally in the form of a spring such as a tension spring is provided. The biasing member 60 has a first end 62 and a second end 64. The first end 62 contacts the aperture flange 120 and the second end 64 contacts the locking member ledge 34. It will be appreciated that the biasing member 60 will bias the locking member 20 in an outward direction. In other words, the biasing member 60 will bias the head 22 of the locking member 20 in a direction from the second side 114 toward the first side 112 of the first housing member 110.

As noted above, the bayonet latch 10 includes a stem 70 that is secured in the second housing member 130. As shown in the figures, the second side 134 of the second member 130 is provided with a boss 136 having internal threads 138. The stem 70 has a first end 72 and a second end 80 with the second end having threads 82 to threadably engage threads 138 in the boss 136. It will be appreciated that by providing threads 82 on the stem 80, the cooperation between the stem 80 and the locking member 20 can be adjusted to increase or decrease the securing engagement between the first 110 and second 130 housing members. Although the stem 70 is rotatable to threadably engage the boss 136 to axially position the stem 70, it is desirable that, once the stem 70 is positioned, it does not rotate. Accordingly, a lock nut 90 may be provided to secure the stem 70 in a set or fixed position.

The first end 72 of the stem 70 has a pin 74 radially extending from the stem 70. The pin 74 has a length, shape, and size such that when the locking member 20 is oriented in a first position, the pin 74 will pass through the slot 42 and when the locking member 20 is rotated, the pin 74 cannot pass through the slot 42. In one embodiment, the pin 74 includes a first portion 76 and a second opposite portion 78 that lies in the same plane as the first portion 76 to define a T shape. In this embodiment, the locking member 20 has a complementary slot 42 such that that when the locking member 20 is oriented in a first position, the pin 74 will pass through the slot 42 and when the locking member 20 is rotated, the pin 74 cannot pass through the slot 42. It will be understood that the pin 74 may have any orientation with respect to the horizontal or vertical. For ease of the user, the pin 74 will generally be oriented horizontally or vertically.

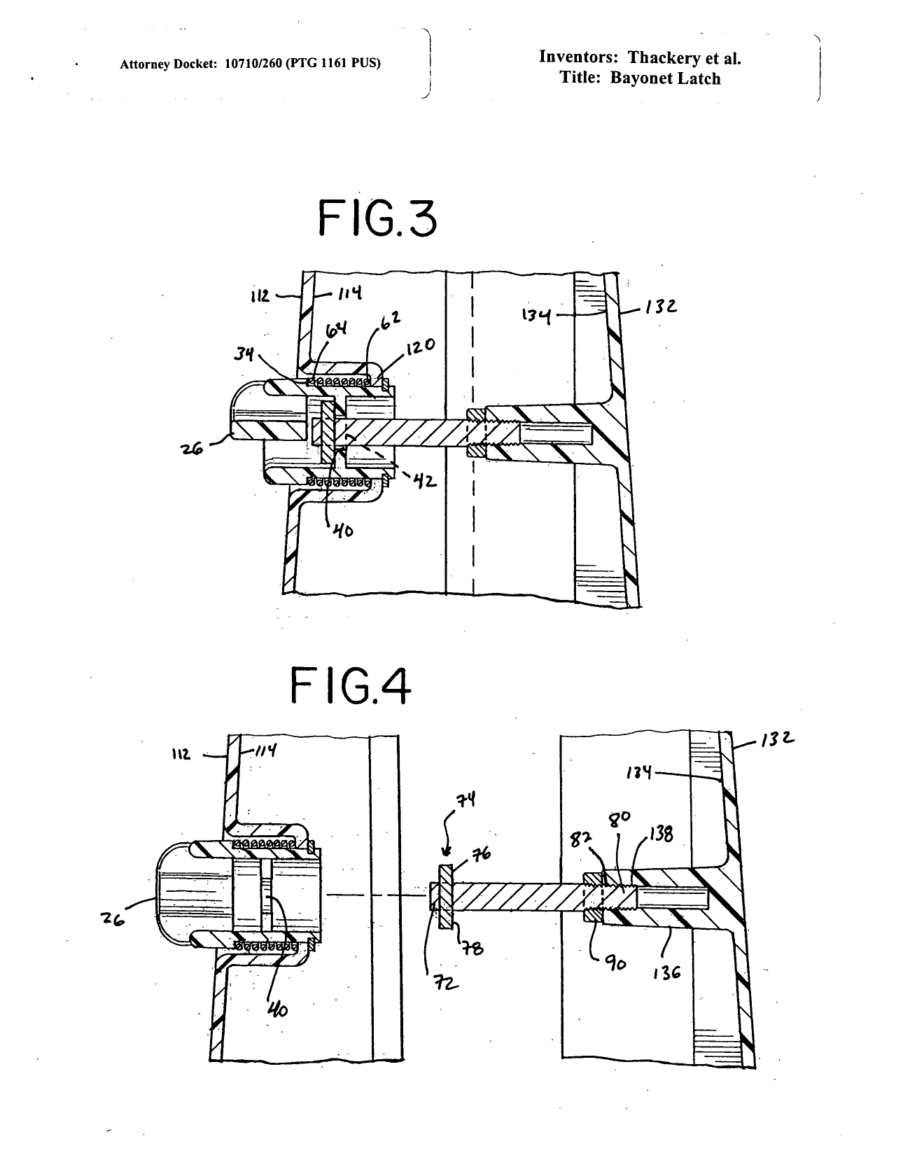

Referring now to FIGS. 3 and 4, operation of the bayonet latch 10 will be described in connection with a housing 100 having a first housing member 110 and a second housing member 130. FIG. 3 shows the first housing member 110 secured to the second housing member 130 by the bayonet latch 10 in a locked position. As shown, the pin 74 is oriented in a vertical direction. In the locked position, the slot 42 is located in a position with respect to the pin 74 such that the pin cannot pass through the slot 42. Specifically, as shown in FIG. 3, the pin 74 is oriented in a vertical direction. The indicator 26 is shown as horizontal (meaning that the slot is horizontally oriented). Accordingly, the pin 74 cannot pass through the slot 42. In addition, the biasing member 60 biases the locking member 20 in a direction away from the second housing member 130 such that the pin 74 abuts the flange 120 to provide a continual tension against the pin 74. As a result, the second housing member 130 is continually being urged toward the first housing member 110. Advantageously, biasing member 60 can accommodate vibrations and other movements while still providing a continual force urging the housing members 110, 130 together.

To unlock the bayonet latch 10 to a position shown in FIG. 4, the locking member 20 is pushed inwardly or is urged in a direction against the biasing force of the biasing member 60 and then rotated in a direction and to an extent to align the slot 42 with the pin 74 so that the pin 74 can pass through the slot 42 and the housing members 110, 130 can be separated. It will be understood that when the locking member 20 and thus the slot 42 are in a first position (an unlocked position), as shown in FIG. 4, the pin 74 can pass through the slot 42 to either open or shut the housing 100 and that when the locking member 20 and thus the slot 42 is in a second position (a locked position), as shown for example in FIG. 3, the pin 74 cannot pass through the slot 42 and the housing 100 is considered in a locked or latched position. Although FIGS. 3 and 4 show a desired rotational position between the locked and unlocked positions of 90 degrees (a one-quarter turn), it will be understood that the first position and the second position may be rotationally offset from each other an amount other than 90 degrees.

Of course, it should be understood that a wide range of changes and modifications could be made to the embodiments described above. It is therefore intended that the foregoing detailed description be regarded as illustrative rather than limiting, and that it be understood that it is the following claims, including all equivalents, that are intended to define the spirit and scope of this invention.

1. A bayonet latch comprising:
a. a rotatable locking member having a slot;
b. a stem having a pin; wherein when the locking member is in a first position, the pin passes through the slot and when the locking member is in a second position, the pin cannot pass through the slot.

2. The bayonet latch of claim 1 wherein the pin extends laterally outward from the stem.

3. The bayonet latch of claim 1 wherein the pin has a first member extending laterally outward from the stem and a second member opposite the first member and extending laterally outward from the stem to form a T.

4. The bayonet latch of claim 1 wherein the first position and the second position are offset from each other.

5. The bayonet latch of claim 1 wherein the first position and the second position are offset from each other 90 degrees.

6. The bayonet latch of claim 1 further comprising a spring to bias the locking member away from the stem when the locking member is in the second position.

7. The bayonet latch of claim 1 further comprising an indicator provided on the locking member to indicate the positional relationship of the slot with respect to the pin.

8. A bayonet latch for a housing having a first housing member and a second housing member comprising:
a. a rotatable locking member secured in the first housing member;
b. a stem secured from rotation in the second housing member; wherein when the locking member is in a first position, the pin passes through the slot and the housing members can be joined and when the locking member is in a second position, the pin cannot pass through the slot and the housing members are secured to each other.

9. The bayonet latch of claim 8 further comprising a spring to bias the locking member away from the stem when the locking member is in the second position.

10. A bayonet latch for a housing comprising:
a. a first housing member having first side and a second side with a flange provided on the first side to receive a rotatable locking member having a slot;
b. a second housing member having a first side and a second with a boss provided on the second side to receive a stem having a pin; wherein when the locking member is in a first position and the second side of the first housing member contacts the second side of the second housing member, the pin passes through the slot and further wherein when the locking member is rotated to a second position, the second side of the first housing member is held in contact with the second side of the second housing member.

11. The bayonet latch of claim 10 further comprising a spring disposed between the flange and the locking member.

12. The bayonet latch of claim 10 wherein the stem is threadably received in the boss.

13. The bayonet latch of claim 10 wherein the stem has a first member extending laterally outward from the stem and a second member opposite the first member and extending laterally outward from the stem to form a T.

14. The bayonet latch of claim 10 wherein the second position is offset from the first position.
